(19) United States
(12) Patent Application Publication
(10) Pub. No.: US 2015/0140337 A1
(43) Pub. Date: May 21, 2015

(54) POLYMERIC ARTICLE WITH ENHANCED DUCTILITY AND METHOD OF MAKING THE SAME

(71) Applicant: Ford Global Technologies, LLC, Dearborn, MI (US)

(72) Inventors: Rick H. Wykoff, Commerce Township, MI (US); Mohammed Omar Faruque, Ann Arbor, MI (US); Fubang Wu, Troy, MI (US); Yijung Chen, Ypsilanti, MI (US); Matthew John Zaluzec, Canton, MI (US)

(73) Assignee: Ford Global Technologies, LLC, Dearborn, MI (US)

(21) Appl. No.: 14/083,847

(22) Filed: Nov. 19, 2013

(51) Int. Cl. B32B 15/082; C08K 7/14; C08J 5/18; C08J 3/20; B32B 37/18; B32B 15/092; B32B 27/08; B32B 27/38; B32B 27/30; B32B 27/12; B32B 17/06; C08K 7/06; B29C 43/00

(52) U.S. Cl. CPC B32B 15/082; C08K 7/06; C08K 7/14; C08J 5/18; C08J 3/203; B32B 37/182; B29C 43/003; B32B 27/08; B32B 27/38; B32B 27/30; B32B 27/12; B32B 17/064; B32B 15/092; C08J 2363/00; C08J 2333/04; C08J 2367/00; B32B 2311/30; B32B 2311/24; B32B 2313/04; B32B 2315/08; B32B 2331/00; B32B 2363/00; B32B 2367/00; B29K 2031/00
USPC 428/413; 523/458; 523/457; 524/440; 524/441; 264/331.11; 264/261; 428/426; 428/457; 428/442; 428/463

(57) ABSTRACT

According to one or more embodiments, a polymeric article includes a polymeric composition, which in turn includes a polymeric material in a first weight percent, a non-metallic fibrous material in a second weight percent, and a metallic fiber material in a third weight percent and being intermixed with the non-metallic fibrous material. The polymeric material may include at least one of epoxy, vinyl ester, and/or polyester. The fibrous material may include at least one of glass fiber and carbon fiber. The metallic fiber material may include at least one of steel and aluminum.

### TECHNICAL FIELD

The disclosed inventive concept relates generally to polymeric article with enhanced ductility and method of making the same. In certain instances, the polymeric article may be configured as sheet molding compound (SMC).

### BACKGROUND

Sheet molding compound (SMC) or sheet molding composite is a fiber reinforced polymer material primarily used in compression molding. SMC may be provided in rolls and be manufactured by dispersing strands of chopped fibers such as glass fibers or carbon fibers on a bath of polymer such as polyester polymer. Some existing cured SMC parts suffer from inadequate strength and/or ductility.

It would thus be advantageous if system and method for producing a polymeric article may be provided to solve one or more of these identified problems.

### SUMMARY

The disclosed inventive concept is believed to overcome one or more of the problems associated with producing a polymeric article such as sheet molding compound.

According to one or more embodiments, a polymeric article includes a polymeric composition, which in turn includes a polymeric material in a first weight percent, a non-metallic (i.e. carbon or glass) fibrous/fiber material in a second weight percent, and a metallic fibrous/fiber (i.e. stainless steel or aluminum) material in a third weight percent and intermixed with the non-metallic fibrous material. The polymeric material may include at least one of epoxy, vinyl ester, and/or polyester. The fibrous material may include at least one of glass fiber and carbon fiber. The metallic fiber material may include at least one of steel and aluminum

The polymeric article may further include at least one cover layer contacting the polymeric composition. The at least one cover layers may include first and second cover layers sandwiching the polymeric composition.

In certain instances, the polymeric material, the non-metallic fibrous material and the metallic fiber material are intermixed to be an intermixture. In certain other instances, the polymeric material is configured as first and second polymeric material layers. In certain particular instances, the fibrous material and the metallic material are sandwiched between the first and second polymeric material layers.

In certain other instances, the first polymeric material layer includes a first polymer, and the second polymeric material includes a second polymer same or different from the first polymer.

According to one or more other embodiments, a polymeric article includes a polymeric composition, which in turn includes a polymeric material in 30 to 84 weight percent, a non-metallic fibrous material in 15 to 45 weight percent, and a metallic fiber material in 1 to 25 weight percent; and at least one cover contacting the polymeric composition.

According to yet one or more other embodiments, a method of forming a polymeric article includes subjecting a polymeric composition to a compression mold to form the polymeric article, the polymeric composition including a polymeric material in a first weight percent, a non-metallic fibrous material in a second weight percent, and a metallic fiber material in a third weight percent and being intermixed with the non-metallic fibrous material, the third weight percent being no greater than the first or second weight percent.

The above advantages and other advantages and features will be readily apparent from the following detailed description of embodiments when taken in connection with the accompanying drawings.

### BRIEF DESCRIPTION OF THE DRAWINGS

For a more complete understanding of embodiments of this invention, reference should now be made to the embodiments illustrated in greater detail in the accompanying drawings and described below by way of examples wherein:

FIG. 1A illustratively depicts a cross-sectional view of a polymeric article according to one or more embodiments;

FIG. 1B illustratively depicts a plan view of the polymeric article referenced in FIG. 1A;

FIG. 10 illustratively depicts a cross-sectional view of a variation to the polymeric article referenced in FIG. 1A;

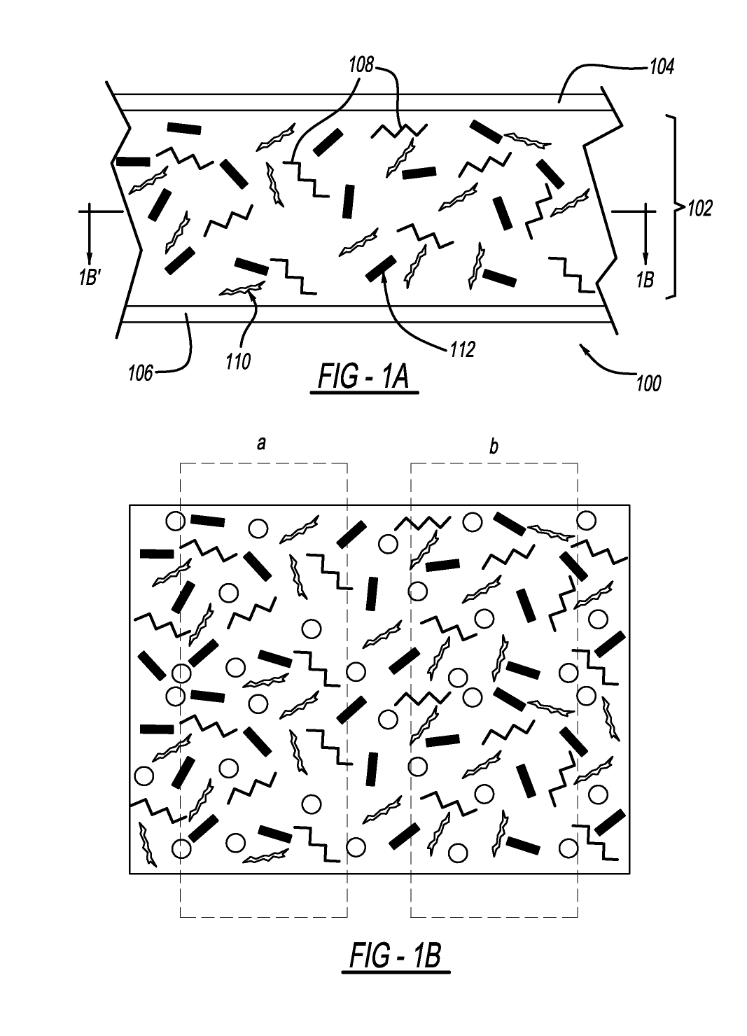

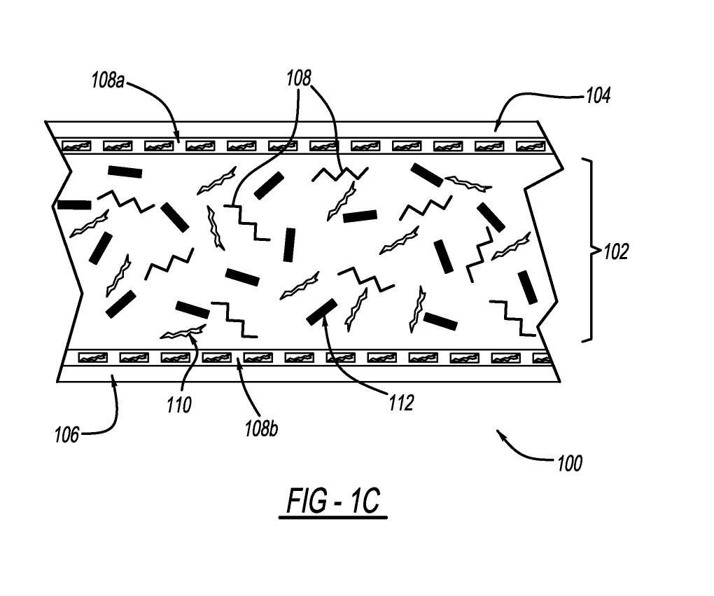

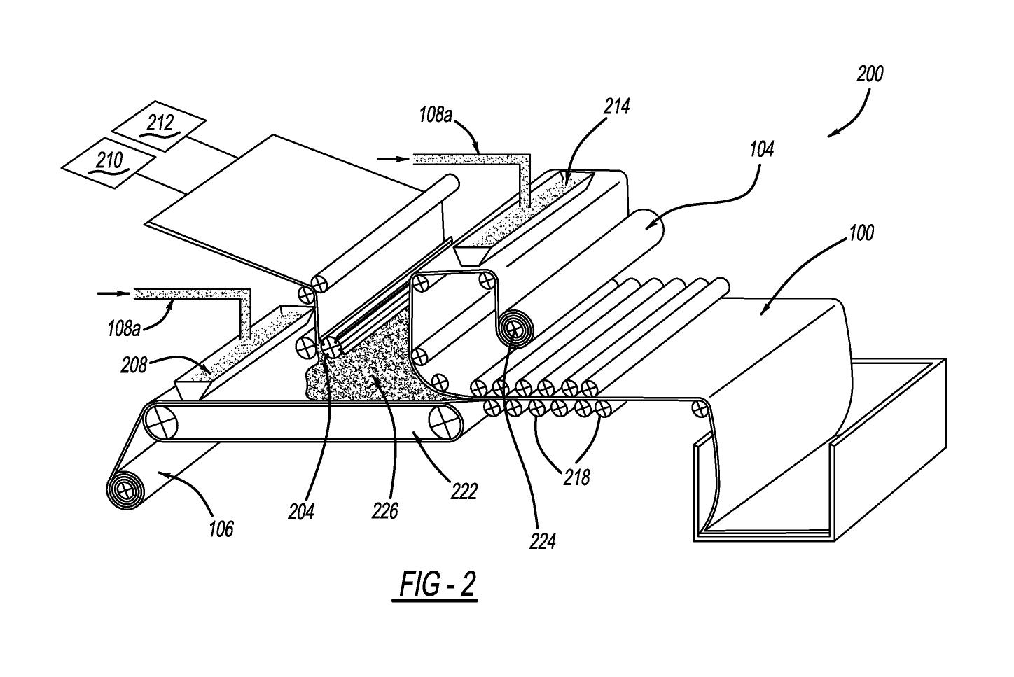

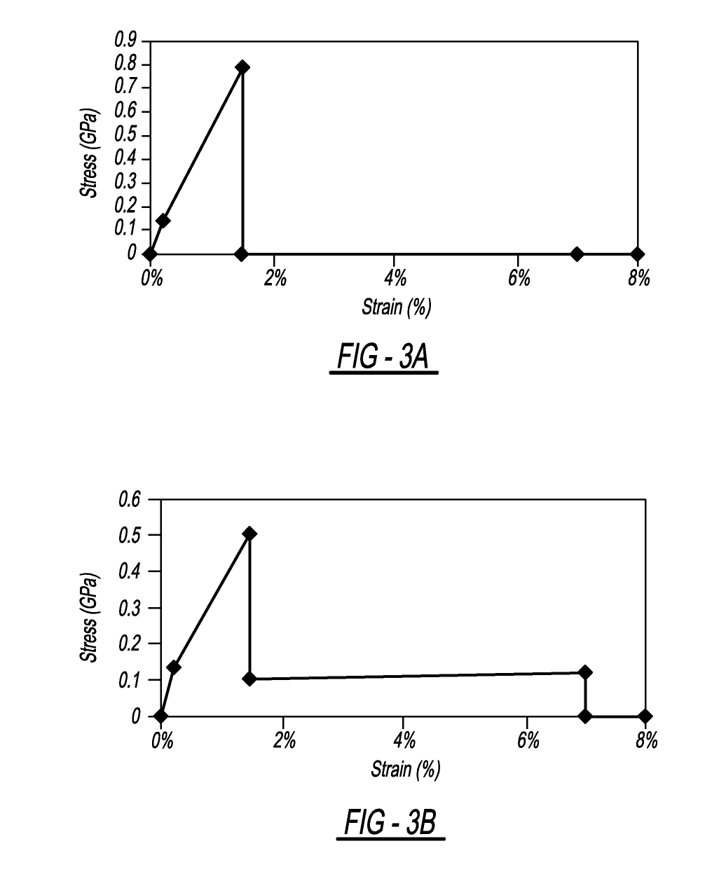

FIG. 2 depicts a system for forming sheet molding compound referenced in FIG. 1A;

FIG. 3A and FIG. 3B show comparatively show certain performance parameters of polymeric compositions referenced in the Example; and

FIG. 4 shows certain performance parameters of several polymeric compositions referenced in the Example.

### DETAILED DESCRIPTION OF ONE OR MORE EMBODIMENTS

As referenced in the FIG.s, the same reference numerals are used to refer to the same components. In the following description, various operating parameters and components are described for different constructed embodiments. These specific parameters and components are included as examples and are not meant to be limiting.

The present invention in one or more embodiments is advantageous by acknowledging that certain existing polymeric articles such as sheet molding compound is met with limited use for lacking desirable ductility. This is at least in part due to the observation that certain fibers such as glass and carbon fibers tend to be brittle and so is the resultant sheet molding compound. The sheet molding compound thus formed cannot readily be used for certain load-carrying constructions.

The present invention in one or more embodiments is thus advantageous by providing a polymeric article including a polymeric composition, which in turn includes a polymeric material, a fibrous material and a metallic material, with desirable features in strength and ductility. Without wanting to be limited to any particular theory, it is believed that while the fibrous material provides the strength, the metallic material supplement the polymeric composition with a synergistic increase in ductility and a concurrent reduction in cost due to a decrease in the amount of fibrous material otherwise used.

Accordingly, the present invention in one or more embodiments introduces a mixture of fibers, together creating a hybrid composite. This combination of fibers is believed to enable the ability to tailor the composite for specific properties which can be used to meet various strength, stiffness and ductility requirements for a number of different applications. As will be detailed herein elsewhere, the polymeric composition includes a polymeric material in a first weight percent, a non-metallic fibrous material in a second weight percent, and a metallic fiber material in a third weight percent and being intermixed with the non-metallic fibrous material. In certain instances, the third weight percent is no greater than the first or second weight percents.

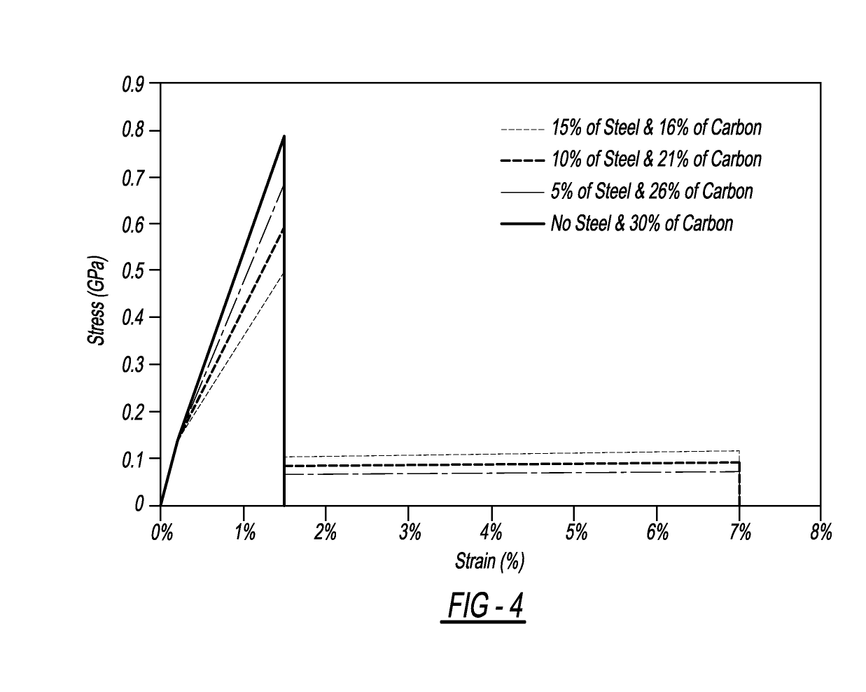

The polymeric composition may be formulated and configured into a sheet molding compound. A non-limiting example of the sheet molding compound and a process of making the same is described below in view of FIG. 1A, FIG. 1B, FIG. 10 and FIG. 2.

FIG. 1A illustratively depicts a cross-sectional view of a polymeric article shown at 100, and FIG. 1B illustratively depicts a plan view of the polymeric article 100 referenced in FIG. 1A taken along the line of 1B′-1B. The polymeric article 100 includes a polymeric composition 102 which in turn includes a polymeric material 108, a fibrous material 110 and a metallic material 112. The polymeric article 100 may further include a first cover layer 104, second cover layer 106, with the polymeric composition 102 disposed between the first and second cover layers 104, 106.

When as needed, and in certain instances, various components of the polymeric composition 102 including the polymeric material 108, the non-metallic fibrous material 110, and the metallic fiber material 112 are intermixed. The intermixing may be accomplished by pre-mixing the polymeric material 108, the fibrous material 110, and the metallic material 112 to form an intermixture and the intermixture is then placed between the first and second cover layers 104, 106.

The term “intermixed” may be specified as follows. Portions “a” and “b” of the polymeric composition 102 are randomly selected and of same volume. The term “intermixed” may be determined when a weight percent of one or more of the polymeric material 108, the fibrous material 110, and the metallic material 112 in the portion “a” is substantially identical relative to a weight percent of each of their corresponding counterpart in the portion “b”. Two weight percent values are substantially identical when one weight percent is 90 percent to 110 percent or 95 percent to 105 percent relative to the other.

A variation is illustratively depicted in FIG. 10, wherein the polymeric material is configured as first and second polymeric material layers 108a and 108b, and wherein the fibrous material 110 and the metallic material 112 are positioned between first and second polymeric material layers 108a, 108b. Therefore the polymeric composition 102 is configured in a sandwich type structure with the first and second polymeric material layers 108a, 108b sandwiching the fibrous and metallic materials 110, 112. The resulting polymeric composition 102 may then be sandwiched between first and second cover layers 104 and 106 as depicted in FIG. 1A and FIG. 1B.

The polymeric article 100 may be produced using a system generally shown at 200 illustratively depicted in FIG. 2. Referring to FIG. 2, a first or lower cover layer 106 is conveyed onto a conveyor 222. A second or upper cover layer 104 is provided via rollers 224. Roving 210 provides the source for the fibrous material 110 referenced in FIG. 1A to FIG. 10. Roving 212 provides the source for the metallic material 112 referenced in FIG. 1A to FIG. 10. Roving 210 and roving 212 may be supplied as continuous strands and are then chopped to form the metallic material 112 and the fibrous material 110 in chopped fibers, collectively shown at 226. The chopped fibers 226 may be intermixed to form an intermixture of the metallic material 112 and the fibrous material 110.

The chopped fibers 226 are deposited between the lower cover layer 106 and upper cover layer 104. A first polymer doctor box 208 is positioned adjacent to the lower cover layer 106 and applies a first polymeric material 108b to the lower cover layer 106. The chopped fibers 226 are deposited on the first polymeric material 108b on the lower cover layer 106. A second polymer doctor box 214 is positioned adjacent to the upper cover layer 104 and applies a second polymeric material 108a to the upper cover layer 104.

The first and second polymeric materials 108b, 108a are each dispensed in a measured amount onto the lower cover layer 106 and upper cover layer 104, respectively. The lower cover layer 106 passes underneath a chopper 204, which cuts the roving 210 and the roving 212 to form the chopped fibers 226. The chopped fibers 226 are then dropped onto the lower cover layer 106. Once the chopped fibers 226 have drifted through the depth of first polymeric material 108b on the lower cover layer 106, the upper cover layer 104 is added on top which sandwiches the chopped fibers 226. The thus formed sandwich sheets may be compacted through compression rollers 218 and then enter onto a take-up roll, which is used to store the product whilst it matures. The cover layers 104, 106 may later be removed and the material without the cover layers may then be cut into shapes. Due to the initial placement of the chopped fibers 226 at the center of the sandwich, they generally remain at the interior portions of a molded part away from the surface.

Referring back to FIG. 2, although two separate sources 210, 212 are shown to represent the sources for the fibrous material 110 and the metallic material 112, fewer or more sources may be used as suitable. For instance, one combined source may be used for providing the material source for the fibrous material 110 and the metallic material 112. For instance also, two or more separate sources may be used to provide the material source for the fibrous material 110, and two or more separate sources may be used to provide the material source for the metallic material 112. A benefit of this design would likely to provide a greater intermixing of the source materials.

Alternatively, the first polymeric material 108b and/or the second polymeric material 108a may be directly deposited into the chopped fiber 226 to form an intermixture, prior to contacting the first cover layer 106 or the second cover layer 104. The intermixing may be carried out in a separate container (not shown).

The polymeric material 108 as referenced in FIG. 1A and the first and second polymeric material layers 108b, 108a as referenced in FIG. 10 may each independently be of any suitable composition, and may include one or more polymers. In certain instances, the polymeric material 108 as referenced in FIG. 1A and the first and second polymeric material layers 108b, 108a as referenced in FIG. 10 may each independently include at least one of epoxy, vinyl ester and polyester.

The fibrous material 110 may include one or more types of fibers. In certain instances, the fibrous material 110 includes at least one of a glass fiber and a carbon fiber.

The metallic material 112 may include one or more types of metals, metal alloys or metal oxides. In certain instances, the metallic material 112 includes at least one of steel and aluminum.

Doctor box 208 is arranged to provide the first polymeric material 108b to the lower cover layer 106. Likewise, doctor box 214 is arranged to provide the second polymeric material 108a to the upper cover layer 104. The first polymeric material 108b may be applied to the lower cover layer 106 immediately prior to receiving the chopped fibers 226. Likewise, the second polymeric material 108a may be applied to the upper cover layer 104 immediately prior to receiving the chopped fibers 226. The doctor box 208 includes a doctor blade 204 so that polymer deposited by the doctor box 208 is evenly applied to the lower cover layer 106.

After the polymeric article 100 is formed, it may be cut into a desired length or cut in a blanking operation to a desired blank shape. After the polymeric article 100 is cut, the cover layers 106 and 104 may be subsequently removed, and the cut pieces are then placed in conventional molding equipment to form parts of desirable contour.

The sheet molding compound parts may be produced in general by molding the sheet molding compound in matched die sets that apply heat and pressure to cure the sheet molding compound into a desired shape, which is imparted with relatively higher strength, relatively lower lightweight, relatively higher dimensional stability and corrosion resistance.

The polymeric article 100, optionally in the form of sheet molding compound, may be used to form various structural components and particularly structural components in vehicular applications. The various structural components may include body panels, engine components, vehicle frame elements, bumper beams, fan shrouds, and many other types of components. The use of sheet molding compound introduces a number of advantages including providing lower weight, greater consolidation of parts, ability to use less complex and expensive tooling for molding the parts, greater range of component styling, and short cycle times for the molding processes.

### EXAMPLE

Certain non-limiting examples of the polymeric composition are tabulated below according to one or more embodiments of the present invention. The performance of crash safety is specified by the ductility of the compositions. The tabulated compositions are believed to all achieve a general stiffness target of 70 GPa in elastic modulus.

The following three tables, namely Table 1, Table 2 and Table 3, show certain stiffness and safety parameters based on variations to the type of the polymeric material, the non-metallic fibrous material, and whether metal is included. In essence, these tables function as an exemplary look-up matrix for one to obtain some predictions in stiffness, strength and/or ductility based upon a change in ingredients.

TABLE 1
using epoxy as the polymeric material

| Contents | | | Composition (%) | | | Stiffness | Strength | Ductility | |
|---|---|---|---|---|---|---|---|---|---|
| | carbon/ | | | carbon/ | | Elastic Module | tensile stress | ultimate | ductile residule |
| matrix | glass | metal | matrix | glass | metal | (GPa) | (GPa) | strain (%) | stress (GPa) |
| epoxy | carbon | no metal | 70% | 30% | 0% | 70 | 0.789 | 1.49% | 0.000 |
| | | steel | 70% | 25% | 5% | 70 | 0.691 | 7.00% | 0.071 |
| | | | 70% | 20% | 10% | 70 | 0.593 | 7.00% | 0.093 |
| | | | 69% | 16% | 15% | 70 | 0.496 | 7.00% | 0.115 |
| | | aluminum | 67% | 28% | 5% | 70 | 0.756 | 7.00% | 0.061 |
| | | | 63% | 27% | 10% | 70 | 0.724 | 7.00% | 0.074 |
| | | | 60% | 25% | 15% | 70 | 0.695 | 7.00% | 0.087 |
| | glass | steel | 42% | 38% | 20% | 70 | 0.127 | 7.00% | 0.119 |

TABLE 2
using vinyl ester as the polymeric material

| Contents | | | Composition (%) | | | Stiffness | Strength | Ductility | |
|---|---|---|---|---|---|---|---|---|---|
| | carbon/ | | | carbon/ | | Elastic Module | tensile stress | ultimate | ductile residule |
| matrix | glass | metal | matrix | glass | metal | (GPa) | (GPa) | strain (%) | stress (GPa) |
| vinyl ester | carbon | no metal | 70% | 30% | 0% | 70 | 0.782 | 1.49% | 0.000 |
| | | steel | 70% | 25% | 5% | 70 | 0.684 | 4.50% | 0.059 |
| | | | 69% | 21% | 10% | 70 | 0.586 | 4.50% | 0.081 |
| | | | 69% | 16% | 15% | 70 | 0.489 | 4.50% | 0.103 |
| | | aluminum | 67% | 28% | 5% | 70 | 0.750 | 4.50% | 0.050 |
| | | | 63% | 27% | 10% | 70 | 0.719 | 4.50% | 0.064 |
| | | | 60% | 25% | 15% | 70 | 0.687 | 4.50% | 0.077 |
| | glass | steel | 42% | 38% | 20% | 70 | 0.120 | 4.50% | 0.112 |

TABLE 3
using polyester as the polymeric material

| Contents | | | Composition (%) | | | Stiffness | Strength | Ductility | |
|---|---|---|---|---|---|---|---|---|---|
| | carbon/ | | | carbon/ | | Elastic Module | tensile stress | ultimate | ductile residule |
| matrix | glass | metal | matrix | glass | metal | (GPa) | (GPa) | strain (%) | stress (GPa) |
| polyester | carbon | no metal | 70% | 30% | 0% | 70 | 0.784 | 1.49% | 0.000 |
| | | steel | 70% | 25% | 5% | 70 | 0.686 | 3.00% | 0.058 |
| | | | 69% | 21% | 10% | 70 | 0.589 | 3.00% | 0.081 |
| | | | 69% | 16% | 15% | 70 | 0.491 | 3.00% | 0.103 |
| | | aluminum | 67% | 28% | 5% | 70 | 0.752 | 3.00% | 0.050 |
| | | | 63% | 27% | 10% | 70 | 0.721 | 3.00% | 0.063 |
| | | | 60% | 25% | 15% | 70 | 0.689 | 3.00% | 0.077 |
| | glass | steel | 41% | 39% | 20% | 70 | 0.120 | 3.00% | 0.111 |

As shown in the above tables, stiffness may be represented by values in elastic modulus, strength may be represented by values in tensile strength, and ductility may be represented by values in failure strain.

Table 1 shows in particular that ductility (i.e. failure strain) increases from 1.49% to 7% when metal fibers are added in access of 5%. In addition, inclusion of metal fibers causes an increase in ductile residual stress from 0.000 to 0.071 with steel and to 0.061 with aluminum. Similar response trends are also observed with Table 2 and Table 3.

Using epoxy as an exemplary matrix polymer and carbon as an exemplary fiber component, ductile residual stress in GPa is plotted against the values of strain in %, with or without the inclusion of steel fibers. The results are shown in FIG. 3A (with 30% of carbon and no steel) and FIG. 3B (with 16% of carbon and 15% of steel). As can be seen from FIG. 3A and FIG. 3B, replacement of a portion of the carbon fiber with steel, at about 15%, effects a net of protection in ductility for a relatively broad strain range from about 1.5% to 7%, wherein the ductile residual strength is consistently maintained at about 0.1 GPa.

Data taken from Tables 1-3 are plotted similarly according to FIGS. 3A-3B and results are shown in FIG. 4. From what is shown in FIG. 4, it may at least be inferred that for applications in vehicle crash safety, a balance of material strength and ductility may be required to achieve relatively optimal performance. Strength alone without ductility may result in impact pulse that is often dangerous or a possible part breakage which may further induce catastrophic rupture. These suggested formulations are to increase ductility with an acceptable compromise in strength, while maintaining material stiffness.

The present invention in one or more embodiment, and in view of the Example described herein, presents a departure from certain existing processes wherein fibrous materials such as carbon fibers are used in sometimes excess amount in an otherwise unfounded attempt to increase strength of a resultant polymeric article. Here, and to the contrary, the polymeric article or the polymeric composition according to one or more embodiments of the present invention employs the use of the fibrous material such as carbon fibers in a relatively reduced amount and employs the concurrent addition of a metallic fiber material which is relatively cheaper than carbon fibers, and together brings out an end product that is relatively cheaper, more ductile, while maintaining a satisfactory amount of strength and stiffness.

In one or more embodiments, the disclosed invention as set forth herein overcomes the challenges faced by known production of polymeric articles. However, one skilled in the art will readily recognize from such discussion, and from the accompanying drawings and claims that various changes, modifications and variations can be made therein without departing from the true spirit and fair scope of the invention as defined by the following claims.

What is claimed is:

1. A polymeric article comprising:
a polymeric composition including a polymeric material in a first weight percent; a fibrous non-metallic material in a second weight percent, and a metallic fiber material in a third weight percent and being intermixed with the non-metallic fibrous material.

2. The polymeric article of claim 1, wherein the polymeric material, the non-metallic fibrous material and the metallic fiber material are intermixed to be an intermixture.

3. The polymeric article of claim 1, wherein the polymeric material is configured as first and second polymeric material layers.

4. The polymeric article of claim 3, wherein the non-metallic fibrous material and the metallic fiber material are sandwiched between the first and second polymeric material layers.

5. The polymeric article of claim 3, wherein the first polymeric material layer includes a first polymer and the second polymeric material includes a second polymer same or different from the first polymer.

6. The polymeric article of claim 1, further comprising at least one cover layer contacting the polymeric composition.

7. The polymeric article of claim 6, wherein the at least one cover layers includes first and second cover layers sandwiching the polymeric composition.

8. The polymeric article of claim 1, wherein the polymeric material includes at least one of epoxy, vinyl ester and polyester.

9. The polymeric article of claim 1, wherein the non-metallic fibrous material includes at least one of glass fiber and carbon fiber.

10. The polymeric article of claim 1, wherein the metallic fiber material includes at least one of steel and aluminum.

11. The polymeric article of claim 1, wherein the metallic material is provided in the third weight percent to impart to the polymeric article a strength value of 65 to 75 GPa in elastic modulus.

12. The polymeric article of claim 1, wherein the third weight percent of the metallic fiber material is 1 to 25 percent by weight.

13. A polymeric article comprising:
a polymeric composition including a polymeric material in 30 to 84 weight percent, a non-metallic fibrous material in 15 to 45 weight percent, and a metallic fiber material in 1 to 25 weight percent; and
at least one cover layer contacting the polymeric composition.

14. The polymeric article of claim 13, wherein the polymeric material, the non-metallic fibrous material and the metallic fiber material are intermixed to be an intermixture.

15. The polymeric article of claim 13, wherein the polymeric material is configured as first and second polymeric material layers.

16. The polymeric article of claim 15, wherein the non-metallic fibrous material and the metallic fiber material are sandwiched between the first and second polymeric material layers.

17. The polymeric article of claim 13, wherein the first polymeric material layer includes a first polymer, and the second polymeric material includes a second polymer same or different from the first polymer.

18. A method of forming a polymeric article, comprising:
subjecting a polymeric composition to a compression molding to form the polymeric article, the polymeric composition including a polymeric material in a first weight percent, a non-metallic fibrous material in a second weight percent, and a metallic fiber material in a third weight percent and intermixed with the non-metallic fibrous material.

19. The method of claim 1, wherein the polymeric composition is formed by intermixing the polymeric material, the non-metallic fibrous material and the metallic fiber material.

20. The method of claim 1, wherein the polymeric composition is formed by placing the non-metallic fibrous material and the metallic fiber material between the two separate layers of the polymeric material.
